(19) United States
(12) Patent Application Publication
(10) Pub. No.: US 2016/0126665 A1
(43) Pub. Date: May 5, 2016

(54) MAGNETIC ELECTRICAL APPLIANCE CONNECTING STRUCTURE

(71) Applicant: YU-CHENG YANG, Tainan (TW)

(72) Inventor: YU-CHENG YANG, Tainan (TW)

(21) Appl. No.: 14/532,813

(22) Filed: Nov. 4, 2014

(51) Int. Cl. H01R 13/62; H01R 13/24

(52) U.S. Cl. CPC H01R 13/6205; H01R 13/24

(57) ABSTRACT

A magnetic electrical appliance connecting structure includes an inserting connection member and an accommodating connection member. The inserting connection member includes an inserting connection housing, two first magnetic elements and a plurality of first conductive elements. Each first conductive element includes a flexible portion, an extension portion and an electrical connection protruding portion. The accommodating connection member includes an accommodating connection housing, two second magnetic elements adapted to be respectively magnetically attracted the two first magnetic elements, and a plurality of second conductive elements. Each second conductive element includes a body and an electrical connection recessed portion. The first conductive elements have an electrically connected state, in which the electrical connection protruding portions are abutted against the respective electrical connection recessed portions to push the extension portions to move toward an inner direction of the inserting connection housing.

### FIELD OF THE INVENTION

The present invention relates to a magnetic electrical appliance connecting structure, and particularly to a magnetic electrical appliance connecting structure that conducts electricity or signals by connecting a male connector with a female connector through a magnetic force.

### BACKGROUND OF THE INVENTION

Electronic products bring the human life with extraordinary conveniences. For example, computers, smart phones, portable disks and printers are essential tools in the daily lives. To allow data exchange among different types of electronic products, transmission interfaces for connectors of electrical appliances are developed, e.g., the RS-232 standard in the earlier days and the common USB standard nowadays. In general, a connector includes a male connector (plug) and a female connector (socket). The male connector has protruding conductive elements, and the female connector is provided with conductive terminal stations corresponding to the conductive elements. By inserting and plugging means, the conductive elements and the conductive terminal stations become electrically connected to transmit electrical signals.

A conventional conductive terminal station usually includes two elastic plates, which abut each other via an elastic force. When a conductive element of a male connector is inserted between the two elastic plates, the conductive element is clamped by the two elastic plates and is provided with a force for securing the conductive element to achieve electrical connection. However, when inserting and plugging a conventional connector, elasticity fatigue of the elastic plates may be resulted due to long-term use such that the clamping force is reduced to lead to poor contact. Further, during the inserting and plugging process, friction is caused between the conductive element and the elastic plates to result in abrasion and wear of contact surfaces between the two, thus reducing the lifespan of the connector. Therefore, there is a need for a solution for improving the prior art.

### SUMMARY OF THE INVENTION

It is an object of the present invention to solve the issue of poor contact caused by the abrasion of conductive terminals and elastic plates that are connected by clamping means in a conventional connector.

To solve the above issue, a magnetic electrical appliance connecting structure is provided by the present invention. The magnetic electrical appliance connecting structure includes an inserting connection member and an accommodating connection member. The inserting connection member includes an inserting connection housing, two first magnetic elements respectively disposed at two opposite sides in the inserting connection housing, and a plurality of first conductive elements disposed in the inserting connection housing and located between the two first magnetic elements. Each of the first conductive elements includes a constantly stretched flexible portion, an extension portion disposed at the flexible portion and extending out of the inserting connection housing, and an electrical connection protruding portion connected to the extension portion. The accommodating connection member includes an accommodating connection housing, two second magnetic elements respectively disposed at two opposite sides in the accommodating connection housing and adapted to be respectively magnetically attracted to the first magnetic elements, and a plurality of second conductive elements disposed in the accommodating connection housing and located between the two second magnetic elements. Each of the second conductive elements includes a body disposed in the accommodating connection housing, and an electrical connection recessed portion revealed outside the accommodating connection housing and disposed correspondingly to one of the electrical connection protruding portions. The first conductive element has an electrically connected state, in which the electrical connection protruding portions abut against the respective electrical connection recessed portions to compress the respective flexible portions, such that the extension portions move toward an inner direction of the inserting connection housing.

Further, the inserting connection housing includes a plurality of pins that are located at the two first magnetic elements and protrude toward an exterior of the inserting connection housing, and the accommodating connection housing is provided with a plurality of slots that are located between the two second magnetic elements and respectively disposed corresponding to the pins.

Further, the inserting connection housing is divided into two semi-housings along a centerline of the two first magnetic elements, and the pins are respectively disposed at the two semi-housings and at two opposite sides of the respective first conductive elements.

Further, the pins disposed at the two semi-housings are in an asymmetrical arrangement relative to the centerline.

Further, each of the electrical connection protruding portions includes a protruding curved surface, and each of the electrical connection recessed portions includes a recessed curved surface corresponding to the protruding curved surface.

Further, the flexible portion, the extension portion and the electrical connection protruding portion form a pogo pin, and the each of the first conductive elements includes a conductive seat electrically connected to the pogo pin.

Further, the two first magnetic elements have opposite flux directions, and the two second magnetic elements also have opposite flux directions.

Further, one side of each of the first magnetic elements is revealed outside the inserting connection housing, and one side of each of the second magnetic elements is revealed outside the accommodating connection housing.

Further, magnetic electrical appliance combining structure further includes a plurality of non-slip patterns disposed at surfaces of the inserting connection housing and the accommodating connection housing.

With the structure set forth above, the present invention provide following effects compared to the prior art.

1. In the present invention, electrical connection is achieved by abutting the electrical connection protruding portions against the respective electrical connection recessed portions, and the electrical connection protruding portions are constantly pushed by the elasticity of the flexible portions. Thus, issues of elasticity fatigue and poor contact of conductive terminal seats utilizing a conventional clamping means are eliminated. Further, abrasion and wear of conductive terminals and elastic pins are prevented to yield a longer lifespan.

2. In the present invention, the first magnetic elements and the second magnetic elements provide magnetic forces that stably combine the electrical connection protruding portions and the respective electrical connection recessed portions. When a user assembles the structure of the present invention along an incorrect direction, repulsive magnetic forces are provided by the first magnetic elements and the second magnetic elements to prevent an incorrect assembly and thus achieve a foolproof effect.

### BRIEF DESCRIPTION OF THE DRAWINGS

FIG. 1A is three-dimensional schematic diagram of a magnetic electrical appliance connecting structure of the present invention.

FIG. 1B is a partial sectional view of FIG. 1A along 1B-1B.

FIG. 2 is a three-dimensional exploded view of a magnetic electrical appliance connecting structure of the present invention.

FIG. 3 is a two-dimensional schematic diagram of an inserting element of the present invention.

FIG. 4 is a three-dimensional schematic diagram of a magnetic electrical appliance connecting structure of the present invention from another viewing angle.

### DETAILED DESCRIPTION OF THE PREFERRED EMBODIMENTS

The foregoing, as well as additional objects, features and advantages of the invention will be more readily apparent from the following detailed description of several preferred embodiments, which proceeds with reference to the accompanying drawings. These non-limiting embodiments are for explaining technical contents of the present invention, and are not to be construed as limitations to the present invention.

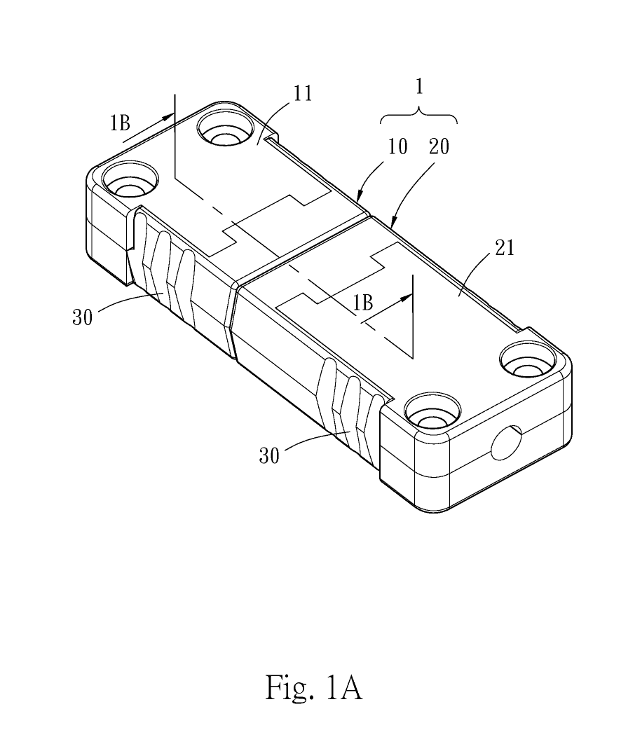

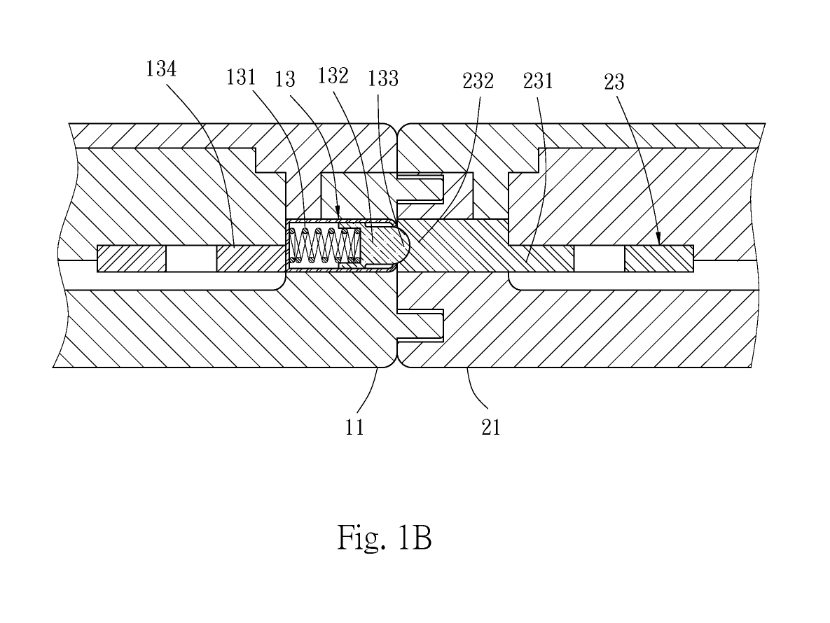

Referring to FIG. 1A for technical contents of the present invention, a magnetic electrical appliance connecting structure 1 of the present invention includes an inserting connection member 10 and an accommodating connection member 20. The inserting connection member 10 and the accommodating connection member 20 may be connected to or disengaged from each other by a user operation, so as to transmit signals or electrical power between the inserting connection member 10 and the accommodating connection member 20.

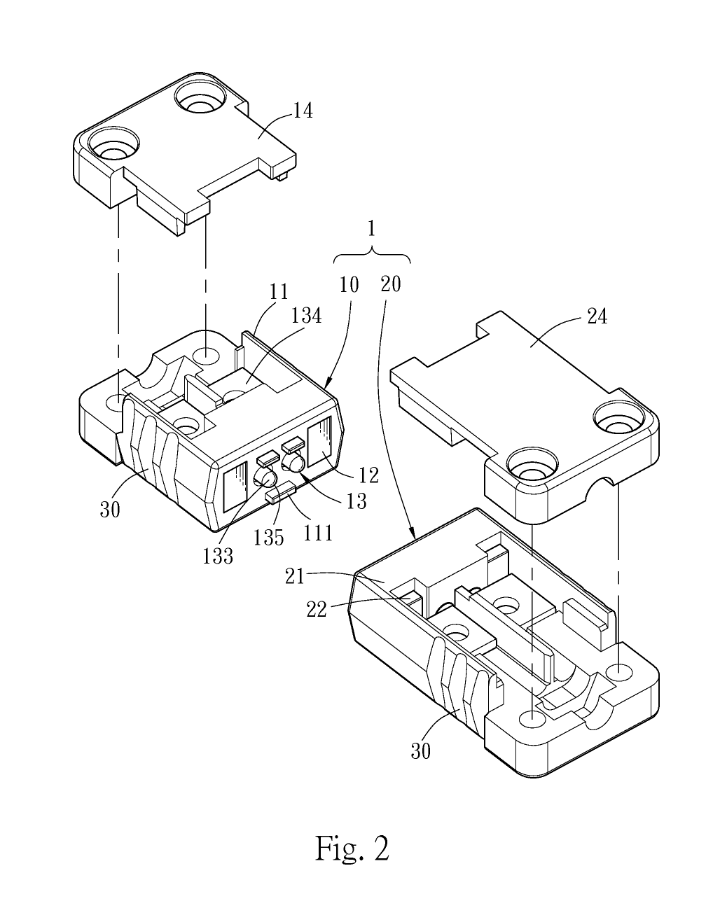

More specifically, referring to FIG. 2, the inserting connection member 10 includes an inserting connection housing 11, two first magnetic elements 12 respectively disposed at two opposite sides in the inserting connection housing 11, and a plurality of first conductive elements 13 disposed in the inserting connection housing 11 and located between the two first magnetic elements 12. In FIG. 2, an inserting connection cover 14 at the inserting connection housing 11 is dissembled to clearly illustrate components in the inserting connection housing 11. The two first magnetic elements 12 may be natural magnets or powerful magnets. Again referring to FIG. 1B, each of the first conductive elements 13 includes a constantly stretched flexible portion 131, an extension portion 132 disposed at the flexible portion 131 and extending out of the inserting connection housing 11, and an electrical connection protruding portion 133 connected to the extension portion 132. In one embodiment, the flexible portion 131, the extension portion 132 and the electrical connection protruding portion 133 form a pogo pin, and the first conductive element 13 includes a conductive seat 134 electrically connected to the pogo pin and adapted to be conducted to an electrical wire (not shown). When the inserting connection member 10 is connected to the accommodating connection member 20, a power source or a signal can be conducted to the conductive seat 134 via the pogo pin to be connected to another electrical appliance (not shown) through the electrical wire.

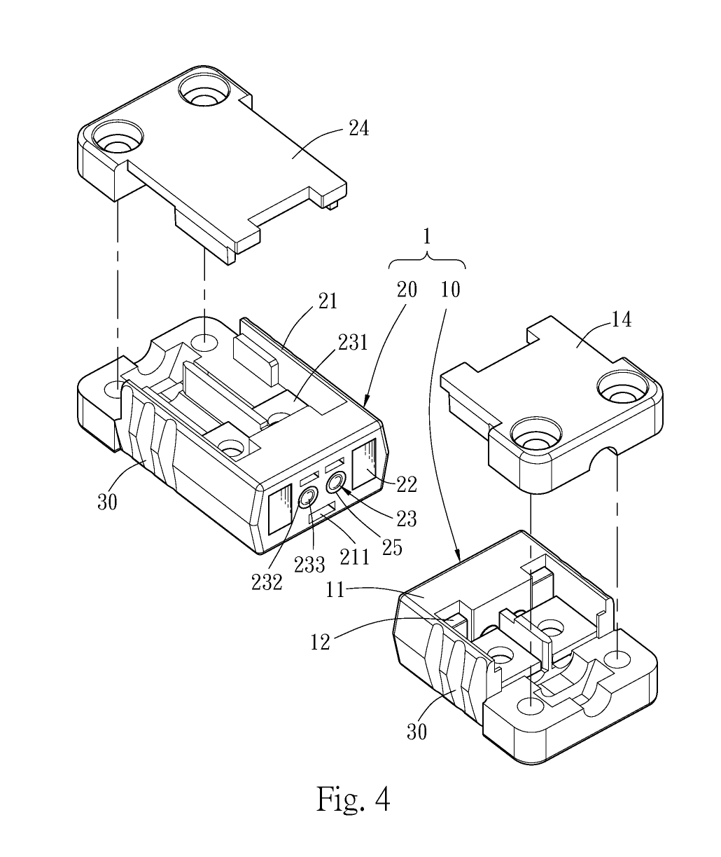

Referring to FIG. 4, the accommodating connection member 20 includes an accommodating connection housing 21, two second magnetic elements 22 respectively disposed at two opposite sides in the accommodating connection housing 21 and adapted to be magnetically attracted to the first magnetic elements 12, and a plurality of second conductive elements 23 disposed in the accommodating connection housing 21 and located between the two second magnetic elements 22. Each of the second conductive element 23 includes a body 231 disposed in the accommodating connection housing 21 and for electrically connecting to an electrical wire (not shown), and an electrical connection recessed portion 232 revealed outside the accommodating connection housing 21 and disposed correspondingly to the electrical connection protruding portion 133. In FIG. 4, an accommodating connection cover 24 at the accommodating connection housing 21 is dissembled to clearly illustrate components in the accommodating connection housing 21.

Again referring to FIG. 1B showing a partial section view of the inserting connection member 10 connected to the accommodating connection member 20, the first conductive element 13 has an electrically connected state. In the electrically connected state of the first conductive element 13, the electrical connection protruding portions 133 abut against the respective electrical connection recessed portions 232 to compress the respective flexible portions 133, such that the extension portions 132 move toward an inner direction of the inserting connection housing 11. In the embodiment, each of the electrical connection recessed portions 232 is revealed outside the accommodating connection housing 21 via a plurality of openings at the accommodating connection housing 21, so as to allow the electrical connection protruding portions 133 to respectively penetrate through the openings 25 (referring to FIG. 4) for electrical connection. The first magnetic elements 12 are respectively attracted to the second magnetic elements 22 to provide the inserting connection member 10 and the accommodating connection member 20 a mutual combining force. Thus, the present invention replaces a conventional clamping method for electrical connection by a contact method for electrical connection, thereby achieving the object of reducing element abrasion and preventing poor contact.

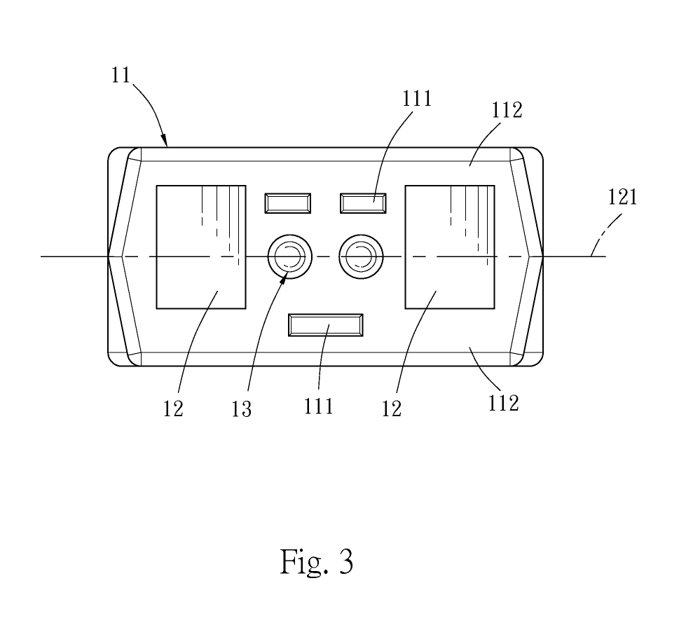

Referring to FIG. 2 to FIG. 4, in another embodiment, the inserting connection housing 11 includes a plurality of pins 111, which are located between the two first magnetic elements 12 and protrude toward an exterior of the inserting connection housing 11. Further, the accommodating connection housing 21 is provided with a plurality of slots 211, which are located between the two second magnetic elements 22 and respectively correspond to the pins 111. The pins 111 may be respectively assembled to the slots 211 to prevent undesired rotations when the inserting connection member 10 and the accommodating connection member 20 are connected. Further, as shown in FIG. 3, the inserting connection housing 11 is divided into two semi-housings 112 along a centerline 121 of the two first magnetic elements 12, and the pins 111 are respectively disposed at the two semi-housings 112 and at two opposite sides of the respective first conductive elements 13. The pins 111 disposed at the two semi-housings 112 are in an asymmetrical arrangement relative to the centerline 121 to prevent a user from connecting the inserting connection member 10 and the accommodating connection member 20 along an incorrect direction. As such, each of the pins 111 and each of the slots 211, and the each of the first magnetic elements 12 and each of the second magnetic elements 22 provide respective securing forces along two orthogonal directions, thereby providing the inserting connection member 10 and the accommodating connection member 20 with a more stable combining result.

In another embodiment, each of the electrical connection protruding portions 133 includes a protruding curved surface 135, and each of the electrical connection recessed portions 232 includes a recessed curved surface 233 corresponding to the protruding curved surface 135. Thus, a contact surface between each of the electrical connection protruding portions 133 and each of the electrical connection recessed portions 232 is a smooth curved surface, so that friction is reduced to minimize abrasion when the electrical connection protruding portions 133 are connected to the respective electrical connection recessed portions 232.

Further, to prevent a user from connecting the inserting connection member 10 and the accommodating connection member 20 along an incorrect direction that may cause damages in an electrical appliance, in one embodiment, the two first magnetic elements 12 have opposite flux directions, and the two second magnetic elements 22 similarly have opposite flux directions. In the event that a user combines the inserting connection member 10 and the accommodating connection member 20 along an incorrect direction, the first magnetic elements 12 and the neighboring second magnetic elements 22 are caused to have the same pole directions to generate repulsive magnetic forces, thereby preventing the user from incorrectly connecting the electrical appliance and achieving a foolproof function. Further, one side of each of the first magnetic elements 12 is revealed outside the inserting connection housing 11, and one side of each of the second magnetic elements 22 is revealed outside the accommodating connection housing 21. Thus, reluctance between the first magnetic elements 12 and the respective second magnetic elements 22 that are connected is reduced, and stronger magnetic attraction forces can then be generated to enhance the combining stability of the inserting connection member 10 and the accommodating connection member 20.

The magnetic electrical appliance combining structure 1 further includes a plurality of non-slip patterns 30 disposed at surfaces of the inserting connection housing 11 and the accommodating connection housing 21. For example, these non-slip patterns 30 may be dented patterns etched on the inserting connection housing 11 and the accommodating connection housing 21, or may be formed by dotted plastic bodies adhered on the surfaces of the inserting connection housing 11 and the accommodating connection housing 21. That is, the implementation form of the non-slip patterns 30 at the inserting connection housing 11 and the accommodating connection housing 21 is not limited by the present invention. When connecting or separating the inserting connection member 10 and the accommodating connection member 20, a user may hold positions of the non-slip patterns 30 by fingers to easily apply a force using the non-slip effect of the non-slip patterns 30.

In conclusion, in the present invention, the inserting connection member and the accommodating connection member are combined using the magnetic forces provided by the first magnetic elements and the second magnetic elements. Further, the electrical connection protruding portions are in contact with the respective electrical connection recessed portions to achieve electrical connection, and the flexible portions are pushed to drive the respective extension portions to withdraw toward the interior of the inserting connection housing to generate elastic forces that securely abut against the electrical connection protruding portions at the respective electrical connection recessed portions. With the above connection means, issues of abrasion caused by connecting and disengaging conventional conductive terminals implemented by a clamping means are eliminated. Thus, the magnetic electrical appliance connecting structure of the present invention offers good electrical connection effects and a longer lifespan.

What is claimed is:

1. A magnetic electrical appliance connecting structure, comprising:
an inserting connection member, comprising an inserting connection housing, two first magnetic elements respectively disposed at two opposite sides in the inserting connection housing, and a plurality of first conductive elements disposed in the inserting connection housing and located between the first magnetic elements, each of the first conductive elements comprising a constantly stretched flexible portion, an extension portion disposed at the flexible portion and extending out of the inserting connection housing, and an electrical connection protruding portion connected to the extension portion; and
an accommodating connection member, comprising an accommodating connection housing, two second magnetic elements respectively disposed at two opposite sides in the accommodating connection housing and adapted to be respectively magnetically attracted to the first magnetic elements, and a plurality of second conductive elements disposed in the accommodating connection housing and located between the two second magnetic elements, each of the second conductive element comprising a body disposed in the accommodating connection housing, and an electrical connection recessed portion revealed outside the accommodating connection housing and disposed correspondingly to the electrical connection protruding portion;
wherein, the first conductive elements have an electrically connected state, in which electrical connection protruding portions abut against the respective electrical connection recessed portions to compress the respective flexible portions, such that the extension portions move toward an inner direction of the inserting connection housing.

2. The magnetic electrical appliance connecting structure of claim 1, wherein the inserting connection housing comprises a plurality of pins located between the two first magnetic elements and protruding toward an exterior of the inserting connection housing, and the accommodating connection housing comprises a plurality of slots located between the two second magnet elements and respectively corresponding to the pins.

3. The magnetic electrical appliance connecting structure of claim 2, wherein the inserting connection housing is divided into two semi-housings along a centerline of the two first magnetic elements, and the pins are respectively disposed at the two semi-housings and at two opposite sides of the respective first conductive elements.

4. The magnetic electrical appliance connecting structure of claim 3, wherein the pins disposed at the two semi-housings are in an asymmetrical arrangement relative to the centerline.

5. The magnetic electrical appliance connecting structure of claim 1, wherein each of the electrical connection protruding portions comprises a protruding curved surface, and each of the electrical connection recessed portions comprises a recessed curved surface corresponding to the protruding curved surface.

6. The magnetic electrical appliance connecting structure of claim 1, wherein the flexible portion, the extension portion and the electrical connection protruding portion form a pogo pin, and each of the first conductive elements comprises a conductive seat electrically connected to the pogo pin.

7. The magnetic electrical appliance connecting structure of claim 1, wherein the two first magnetic elements have opposite flux directions, and the two second magnetic elements have opposite flux directions.

8. The magnetic electrical appliance connecting structure of claim 1, wherein one side of each of the first magnetic elements is revealed outside the inserting connection housing, and one side of each of the second magnetic elements is revealed outside the accommodating connection housing.

9. The magnetic electrical appliance connecting structure of claim 1, further comprising a plurality of non-slip patterns disposed at surfaces of the inserting connection housing and the accommodating connection housing.
